(19) United States
(12) Patent Application Publication
(10) Pub. No.: US 2023/0067630 A1
(43) Pub. Date: Mar. 2, 2023

(54) SYSTEMS AND METHODS FOR HANDLING TRANSFERS

(71) Applicant: The Toronto-Dominion Bank, Toronto (CA)

(72) Inventors: Milos DUNJIC, Oakville (CA); David Samuel TAX, Toronto (CA); Kushank RASTOGI, Toronto (CA); Jonathan Joseph PRENDERGAST, West Chester, PA (US); Asad JOHEB, Toronto (CA)

(73) Assignee: The Toronto-Dominion Bank, Toronto (CA)

(21) Appl. No.: 17/464,746

(22) Filed: Sep. 2, 2021

(51) Int. Cl. G06Q 20/40; G06Q 20/38; G06Q 20/02

(52) U.S. Cl. CPC G06Q 20/405; G06Q 20/382; G06Q 20/389; G06Q 20/02

(57) ABSTRACT

A computer-implemented method is disclosed. The method includes receiving, from a remote system, a transfer message including a transfer quantity and containing metadata regarding the transfer. The system then identifies a main recipient account based on the transfer message and, based on the metadata regarding the transfer, detects a trigger condition. The trigger condition is defined in a handling instruction stored in memory. The handling instruction includes a transfer re-routing action specifying a second recipient account. In response to detecting the trigger condition, the system causes at least a portion of the transfer quantity to be recorded in association with the second recipient account.

### TECHNICAL FIELD

The present application relates to computer handling of transfer messages and, more particularly, to systems and methods for securely processing real-time transfers of resources in a networked environment.

### BACKGROUND

In a computer network, resources may be shared or transferred between nodes of the network. For example, computing resources, such as processing units, memory, etc., may be transferred between nodes in order to attain a desired distribution of resources for a computer network. As another example, electronic transfers of data between data records may effect changes to the quantum of resources associated with the data records.

Requests for transfer of resources may be directed to a computing system that processes and handles such requests. By way of example, a server computer that manages a plurality of resource accounts may handle requests to share, distribute, or otherwise transfer resources that are associated with the accounts. For these systems, processing requests for real-time (or substantially in real-time) transfer of resources may pose a number of challenges. In many situations, a user may have multiple accounts on a system or across multiple different systems, and incoming transferred resources may be inefficiently allocated to one main account. It is incumbent on the user to gain authorized access to the system to then cause a transfer or re-allocation operation to occur to re-direct some or all of the resources to a more suitable data record or account. The delay inherent in reallocating resources correctly may be wasteful and costly for the user. Moreover, the necessity of having the user log in and effect the reallocation is wasteful of server time and bandwidth.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method of processing a request for a transfer of resources associated with a data record;

FIG. 4 illustrates an example graphical interface for configuring a transfer message;

FIG. 5 illustrates a further example graphical interface for configuring a transfer message;

FIG. 6 illustrates an example graphical interface for setting a handling instruction regarding transfer messages; and

FIG. 7 illustrates a further example graphical interface for setting a handling instruction regarding transfer messages.

Like reference numerals are used in the drawings to denote like elements and features.

### DETAILED DESCRIPTION OF VARIOUS EMBODIMENTS

In an aspect, the present disclosure describes a computing system. The computing system includes a processor, a communications module coupled to the processor, and a memory coupled to the processor. The memory stores processor-executable instructions that, when executed by the processor, cause the processor to: receive, from a remote system via the communications module, a transfer message including a transfer quantity and containing metadata regarding the transfer; identify a main recipient account based on the transfer message; based on the metadata regarding the transfer, detect a trigger condition, wherein the trigger condition is defined in a handling instruction stored in the memory, the handling instruction including a transfer re-routing action specifying a second recipient account; and in response to detecting the trigger condition, cause the transfer quantity to be recorded in association with the second recipient account.

In some implementations, the metadata includes a transfer categorization associated with the transfer message. In some cases, the transfer categorization is selected from a list of predefined transfer categorizations. The list of predefined transfer categorizations may include at least one of gift, refund, windfall, or payroll.

In some implementations, the transfer message includes a structured data message having predefined field structure. The metadata may be stored in one or more fields in the predefined field structure.

In some implementations, the instructions, when executed, further cause the processor to validate the metadata by comparing the metadata to a list of predefined transfer categorizations and identifying a match to one of the predefined transfer categorizations, and wherein the trigger condition specifies said one of the predefined transfer categorizations.

In some implementations, the instructions, when executed, further cause the processor to first receive input defining the handling instructions. In some cases, the input further includes a selection of the trigger condition from a list of defined trigger conditions.

In some implementations, the instructions, when executed are to cause by recording the transfer quantity in association with the main recipient account and generating an account transfer operation to record removal of the transfer quantity from the main recipient account and to record credit of the transfer quantity to the second recipient account.

In some implementations, the instructions, when executed are to cause by causing the transfer quantity to be recorded in association with the second recipient account without previously recording the transfer quantity in association with the main recipient account.

In some implementations, the second recipient account is stored at a third party server, and the instructions, when executed are to cause by generating and sending a transfer operation message to the third party server thereby effecting transfer of the transfer quantity from the main recipient account to the second recipient account.

In some implementations, the handling instruction further includes a notification action and the instructions, when executed, are to cause the processor to generate and send a notification message to a recipient contact address regarding receipt of the transfer quantity.

In another aspect, the present application describes a computer-implemented method for handling a transfer. The method may include receiving, from a remote system, a transfer message including a transfer quantity and containing metadata regarding the transfer; identifying a main recipient account based on the transfer message; based on the metadata regarding the transfer, detecting a trigger condition, wherein the trigger condition is defined in a handling instruction stored in memory, the handling instruction including a transfer re-routing action specifying a second recipient account; and in response to detecting the trigger condition, causing at least a portion of the transfer quantity to be recorded in association with the second recipient account.

Other aspects and features of the present application will be understood by those of ordinary skill in the art from a review of the following description of examples in conjunction with the accompanying figures. Example embodiments of the present application are not limited to any particular operating system, system architecture, mobile device architecture, server architecture, or computer programming language.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

The present application makes reference to a “transfer message”, which is a computer-readable message configured for transmission over one or more computer networks between a sending device and a receiving device. The transfer message may be a structured message having a defined schema or set of predefined fields to contain data. The transfer message may be used to transfer resources from one entity to another entity. In particular, the transfer message may be used to effect a change in recorded ownership of resources. The resources may be currency, physical assets, credits, tokenized items like non-fungible tokens, computing resources such as memory allocated or processor time, access rights, or any other resource that may be owned or credited to an account associated with an account holder. In many of the examples below, monetary resources may be referenced to illustrate concepts, but the present application is not necessarily solely applicable to financial or monetary instruments or resources.

In the present application, the terms “transferor” and “transferee” may be used interchangeably with “sender” and “recipient”, respectively, in the context of describing transfers of resources. In some cases, the terms “payor” or “payee” may be used in the example of monetary resources.

In the present application, the “transfer message” may include data that is included in a request for resources to be transferred as between computing devices or computer systems. The data may include basic information regarding the transfer, such as transferor identification data, transferee identification data, and transfer quantity. In some examples, the transferor identification data may include a transferor account identifier specifying the account from which the transferred quantity of resources is being deducted, and the transferee identifier data may include a transferee account identifier specifying the account to which the transferred quantity of resources it to be recorded or credited. In some cases, the transfer message may include additional basic transfer data, such as a unique transfer message identifier, a transfer time, and other such data. The terms “transfer message” and “transfer request” and “transfer instruction” and “transfer command” may be used interchangeably herein.

The transfer message may be formatted as an ISO20022 message in some implementations. The ISO20022 format is a data-rich structured message format that provides for the possibility of including metadata regarding the transfer in addition to the basic information included in transfer messages in more conventional format. The metadata that may be included in an ISO20022 transfer message permits the sending device to include data regarding the purpose of the transfer or parameters to be applied to the transfer. Example metadata may include an invoice number, a third-party customer number, a reference number, etc. Some of the metadata may include a transfer purpose or category. In some cases, the transfer purpose or category may be selected from a predefined list of transfer categorizations. In some cases, the transfer purpose or category may be a free-form field in which any alphanumeric text may be included. The transfer purpose or category field may be referred to as a transfer categorization in some cases.

To the extent that existing transfer processing facilities employ transfer messages that include metadata, the metadata may be received and stored by the recipient computing system, such as a financial institution for example. In conventional transfer processing, the received transfer request results in crediting the transfer quantity to the designated account specified in the transfer request. Any associated metadata may be stored and, in some cases, some portion of the metadata may be made available on an account statement available to be viewed by the account holder. In some cases, the account holder cannot access all or any of the metadata and must contact a financial institution representative or account manager in order to have them access and retrieve stored metadata regarding a received transfer. The account holder may then determine whether to initiate a further transfer or other post-receipt handling of the transferred quantity of resources.

In existing computer systems involving transfer messages, a transfer message may be received that specifies transfer of a certain quantity of resources to a specified account. The receiving system may record that allocation of resources in association with the specified account. In many situations, the specified account is one of a plurality of accounts to which the account holder may allocate resources. In some cases, the account holder may, for various reasons, desire that certain resources, based on their type or source or some other characteristic, be allocated or associated with a certain one of the accounts other than the specified account. In order to re-allocate those resources to a different account, it may then be incumbent upon the account holder to gain authorized access to the recipient computing system, using prescribed authentication mechanisms such as two-factor authentication, in order to input an instruction or command to transfer the resources or a portion of the resource from the specified account to the different account. The delay in transferring the resources may result in wasted resources and/or additional costs for the account holder in having an incorrect allocation of resources. Moreover, the necessity of having the account holder log into the recipient computing system and exchange multiple messaging communications to effect the transfer of resources is wasteful of communication bandwidth and computing power.

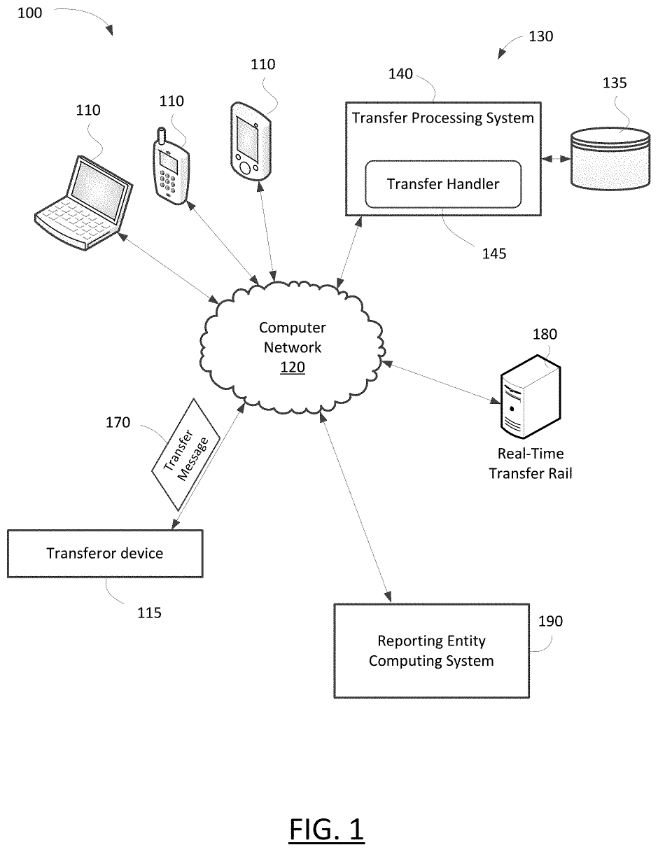

FIG. 1 is a schematic diagram illustrating an operating environment of an example embodiment. In particular, FIG. 1 illustrates exemplary components of a system 100 for processing transfers of resources between computing systems. As a specific example, the system 100 may be implemented to facilitate processing and handling of requests to transfer funds (e.g., payment transactions) between resource accounts (or data records associated therewith). More generally, the components of system 100 enable processing of resource transfer requests that are directed to a resource account management system.

As illustrated, a recipient computing system 130 and one or more client devices 110 communicate via a computer network 120. The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

The client devices 110 are network-capable computing devices. For example, the client device 110 may include various computing devices, including desktop computers, laptop computers, mobile devices, smartphones, tablets, etc. One or more client devices 110 may be configured to access the recipient computing system 130 or another resource storage or accounting system using a dedicated application and/or a web browser. One or more of the client devices 110 may be associated with an account holder that has one or more accounts defined within the recipient computing system 130. The accounts may be associated with account holder log in and authentication data for authenticating requests for access or commands or operations in relation to the accounts.

The recipient computing system 130 may track, manage, and maintain resources for a plurality of users in association with respective defined accounts. The resources may, for example, include computing resources, such as memory or processor cycles. By way of further example, the resources may include stored value, such as fiat currency, which may be represented in one or more databases. For example, as shown in FIG. 1, the recipient computing system 130 may include a database 135, which may be provided in secure storage. In some embodiments, the secure storage may include one or more data centers. The data centers may, for example, store data with bank-grade security.

The recipient computing system 130 may include a transfer processing system 140 configured to receive and authenticate transfer messages and to execute operations to give effect to transfer messages. The transfer processing system 140 may include a transfer handler 145 implemented to automatically process resource transfer requests that are received by the transfer processing system 140. Specifically, the transfer handler 145 may be configured to process requests to transfer resources that are associated with one or more resource accounts managed by the recipient computing system 130. The transfer handler 145 may process resource transfer requests in accordance with defined handling actions. For example, the transfer handler 145 may be configured to automatically process resource a transfer request without manual intervention by related entities (e.g., a resource server administrator, clients associated with the resource accounts, etc.) for the resource transfer requests. In particular, upon receipt of a transfer message allocating resources to an account defined within the recipient computing system 130, and based on a stored handling instruction associated with that account, the transfer handler 145 may re-allocate or redirect the resources to another account specified in the handing instruction. The handling instruction may define a trigger for the re-allocation, which in some cases may include specific metadata within the transfer message.

The transfer handler 145 may be implemented by one or more modules or applications containing processor-executable instructions stored in memory in the transfer processing system 140 and configured to cause one or more processors to carry out operations described herein, once executed by the one or more processors. The present application is not intended to be limited to any specific computing system architecture, operating system, or programming language.

The recipient computing system 130 may, for example, be one or more financial institution servers and the entity associated with one of the client devices 110 may be a customer of a financial institution operating the one or more financial institution servers.

As shown in FIG. 1, the system 100 may include a real-time transfer rail 180. In at least some embodiments, the real-time transfer rail 180 may be a payment rail. For example, the real-time transfer rail 180 may be hosted by a real-time payment system that includes a real-time payment server. The real-time payment system may be associated with a third-party and be configured to receive a resource (e.g., data) transfer request. The resource transfer request may include a request to transfer resources from a first data record to a second data record. The first data record may include a data record associated with a transferor and the second data record may include a data record associated with a recipient. For example, the first data record may be associated with a transferor account in a first financial institution database and the second data record may be associated with a recipient account in a second financial institution database.

The request to transfer resources may be a request to transfer data such as, for example, units of value. The units of value may include a quantity of currency. The transferor may initiate the resource transfer request using, for example, a computing device.

Responsive to receiving a resource transfer request, the real-time payment system may complete the resource transfer request using the real-time transfer rail 180. Specifically, the real-time payment server may be configured to receive the resource transfer request and to facilitate the resource transfer from the first data record associated with the transferor to the second data record associated with the recipient in real-time. In some embodiments, the resource transfer may be irrevocable; that is, the transferor may not be able to retrieve the transferred resources after the transfer.

The real-time transfer rail 180 is configured to complete resource transfer requests in real-time or substantially in real-time. In at least some embodiments, real-time is defined as being within seconds. Certain factors, such as network traffic, may limit the immediacy of real-time transfers and/or processing of transfer requests.

In some implementations, the real-time transfer rail 180 is a third-party transfer rail that operates between respective financial institutions. That is, a transfer message may be sent from one financial institution computing system or a point-of-sale terminal to the real-time transfer rail 180 where it is authenticated and processed in real-time to generate a payment confirmation in response. The real-time processing may include exchanging real-time data with the one financial institution confirming authentication of the transfer message and availability of the resources being transferred. The real-time processing may further include sending communications to the recipient computing system 130 specified in the transfer message. The communications may include a further transfer message, which may or may not be in the same structure or format as the original transfer message, instructing allocation of the transferred funds to a specified account at the recipient computing system 130. In some other implementations, the real-time transfer rail 180 may be a part of the recipient computing system 130.

A transferor device 115, may generate, or to cause a resource management computing system to generate, a resource transfer message 170 that is sent via the computer network 120, and in some cases the real-time transfer rail 180, to the recipient computing system 130. The resource transfer message 170 includes an identifier of an account at the recipient computing system 130 and a transfer quantity. The transfer quantity may be a quantity of resources to be allocated to the account. The resources may include monetary resources or non-monetary resources. The transferor device 115 may include a computing system, a computing device, or one of the client devices 110. In some cases, the transferor device 115 may be a financial institution computing system or server. In some cases, the transferor device 115 may include a payroll processing server.

The resource transfer message 170 may be a structured data message. In some cases, the transfer message 170 may be formatted as an ISO20022 message and may include basic transfer information, such as the transfer quantity, a transferor identifier, and a recipient account identifier. It may further include additional metadata, including, in some implementations, a transfer purpose.

On receipt by the recipient computing system 130 of the transfer message 170, the transfer handler 145 may identify a main recipient account specified in the transfer message 170. It may then verify or authenticate that other data, such as a recipient identifier, matches with local records in the database 135 regarding the main recipient account. It may further determine whether there are any stored handing instructions in the database 135 associated with the main recipient account.

If the main recipient account has an associated handling instructions, then the transfer handler 145 determines whether the handling instruction applies to the transfer message. In some cases, the handling instruction is condition on the message including a particular item or class of metadata. For example, in some cases, the handling instruction may be conditional on the transfer message originating from an identified transferor. In another example, the handling instruction may be condition on the transfer message including a specific transfer purpose or categorization. Other types of metadata and conditions will be described below.

The handing instruction may specify that if the metadata in the transfer message matches the conditional in the handling instruction, then the transfer quantity or some portion of the transfer quantity is to be re-directed or re-allocated to a different account from the main recipient account specified in the transfer message. In some cases this may include recording the transfer quantity or a portion of the transfer quantity directly to the different account. In some cases this may include recording the transfer quantity in the main recipient account and generating and executing a further transfer operation to move the transfer quantity or a portion of the transfer quantity to the different account.

In some cases, the re-allocation is implemented automatically without communications with an authorized account holder or other administrator. In some cases, the re-allocation includes sending a notification to the authorized account holder or administrator. In some cases, the notification includes a solicited confirmation of the reallocation, such as a selectable button or link to confirm or refute the allocation, and the re-allocation is conditional on receipt of that confirmation.

In some examples, the system 100 may further include a reporting entity computing system 190. The reporting entity computing system 190 may include a government or quasi-government computing system, such as a tax revenue reporting service or the like. In some implementations, the handling instruction may further include generating and sending a transfer report to the reporting entity computing system 190 regarding either the transfer message received by the recipient computing system 130 or the re-allocation operation. The transfer report may relate to regulated transfer reporting requirements, for example to tax authorities, a payroll company, a fraud detection entity, foreign income reporting entity, or some other entity that receives and records data regarding certain transfers. The sending of the report may be dependent upon certain metadata being present in the transfer message, as specified in the handling instruction.

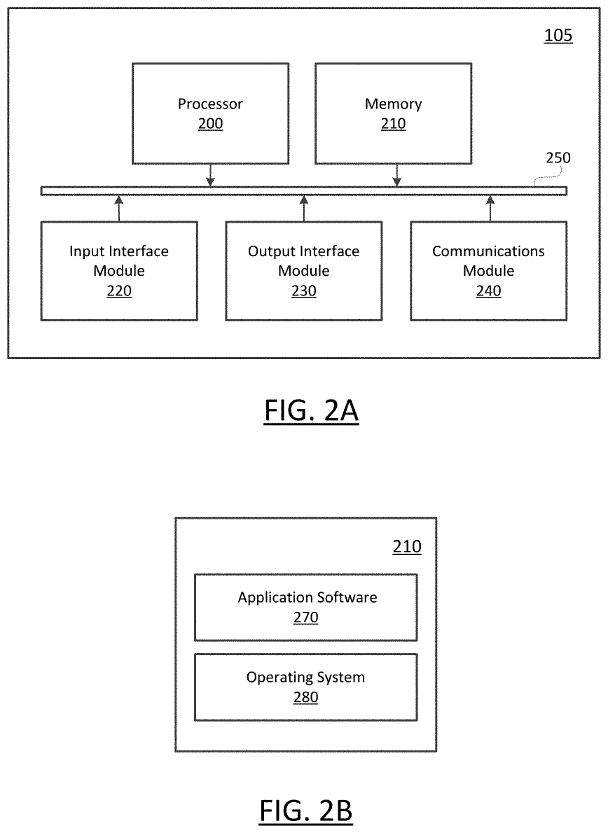

FIG. 2A is a high-level operation diagram of an example computing device 105. In at least some embodiments, the example computing device 105 may be exemplary of one or more of the recipient computing system 130, the transfer processing system 140, the transferor device 115, and/or one or more of the client devices 110. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include application software 270 and an operating system 280.

The application software 270 adapts the example computing device 105, in combination with the operating system 280, to operate as a device performing a particular function. In some embodiments, the application software 270 may include the transfer handler 145. In some examples, the application software 270 may include a transfer generation application executed on the transferor device 115. The transfer generation application may, for example, be a personal banking application that is used to manage one or more banking accounts and to generate transfer commands or instructions relating to those accounts. For example, the application may enable users to configure requests for transfers of resources to accounts associated with other users.

In some cases, the application software 270 may be an account access application that may be used to generate and store handling instructions relating to one or more accounts. A user may input information, or parameters, for defining a handling instruction, such as specifying the account or accounts to which the handling instruction applies, identifying an account, internally or externally, to which resources are to be re-allocated, and specifying any parameters or conditionals defining when the handling instruction is to be carried out. The parameters may include maximum or minimum resource amounts to which the transfer instruction is applied, percentages of resources to be re-allocated, and times, dates, or other factors to be evaluated in determining whether to effect re-allocation, for example. Conditionals may include specifying one or more metadata items to be present in the transfer message to trigger application of the re-allocation. The metadata may be a one or more of a resource type, transferor identity, transfer categorization, or transfer purpose. In some cases, the transfer categorization, transfer purpose, or other metadata is selected from a pre-defined of possible selections. For instance, the transfer purposes may be a set of prescribed possible purposes for the transfer.

The operating system 280 is software. The operating system 280 allows the application software 270 to access the processor 200, the memory 210, the input interface module 220, the output interface module 230 and the communications module 240. The operating system 280 may be, for example, Apple iOS™, Google™ Android™, Linux™, Microsoft™ Windows™, or the like.

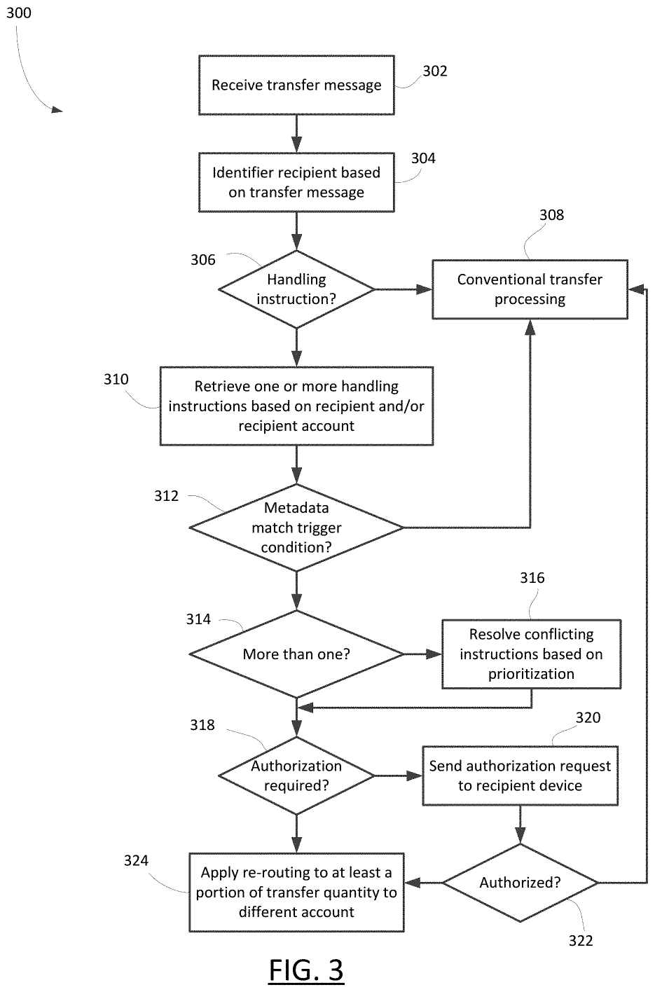

Reference is now made to FIG. 3, which shows, in flowchart form, an example method 300 of processing a transfer message. The method 300 may be implemented by a computing system such as the recipient computing system 130 of FIG. 1. Specifically, the transfer processing system 140 may be configured by software, such as the transfer handler 145, to implement the method 300 as part of its processing of transfer messages. The method 300 may be performed by a computing system that manages one or both of a sender and a recipient account associated with a transfer message. The method 300 may be performed, for example, by the processor 200 (FIG. 2A) of a computing device 105 executing software comprising instructions such as may be stored in the memory 210 of the computing device 105. More particularly, processor-executable instructions may, when executed, configure a processor 200 of the recipient computing system 130 to perform all or parts of the method 300. In this example, the system receiving the transfer message is referred to as a transfer processing system.

The method 300 may be initiated in some cases with receipt of a transfer message by the transfer processing system, as indicated by operation 302. The transfer message may be received from a client device, a payment processor, a payroll computing system, a third-party financial institution computing system, a real-time payment rail, or some other computing system. The transfer message includes, at least, a transfer quantity and an identifier of a recipient and/or recipient account.

In operation 304 the transfer processing system identifies a recipient based on the transfer message. The recipient may be identified by name in the transfer message in some cases, e.g. as a payee or beneficiary of the resource transfer, or may be identified based on an account number, unique identifier, or contact information such as an email address, phone number, or other identifying address that is associated with a particular account holder in the database records of the transfer processing system. In some cases, operation 304 involves identifying an account instead of an account holder. The transfer message may include an identifier of a recipient account, e.g. an account number. The transfer processing system may verify that it has a matching record for that account identifier and may, based on that record, identify the account holder and/or any related or associated accounts.

In operation 306, the transfer processing system determines whether there is a handling instruction stored in memory in association with the recipient and/or the recipient account identified in operation 304. If not, then the system proceeds to operation 308 to process the transfer message in a convention matter. That processing may include any validation or authentication operations normally applied to the transfer message and, assuming the message is valid and authentic, the recording of the transfer in the database at the transfer processing system. This may include recording the transfer quantity to the recipient account. This may further include sending an acknowledgement or confirmation message to the system that sent the transfer message in some implementations.

If there is a handling instruction stored in memory in association with the recipient or the recipient account, then in operation 310 the handing instruction is retrieved from memory. More than one handling instruction may be retrieved from memory if there is more than one handling instruction associated with the recipient account and/or recipient.

In operation 312, the transfer processing system determines whether metadata in the transfer message matches a trigger condition in one of the retrieved handling instructions. The trigger condition may specify a particular code, number, word or selected predefined identifier in the metadata. If the metadata in the transfer message does not contain the specified word or code, then the handling instruction does not apply and the transfer message is processed in the conventional manner in operation 308. However, if the transfer message metadata matches the trigger condition in one or more of the handling instructions, then the method 300 proceeds to special handling of the transfer message.

In operation 314, the transfer processing system assesses whether more than one trigger condition has been detected based on the metadata of the transfer message; that is, whether more than one handling instructions applies to the transfer message. The recipient account may have multiple handling instructions defined in memory that are applicable to it. In some cases, a recipient account holder may have a general handling instruction applicable to all accounts based on one set of trigger data, e.g. payments over a certain dollar amount, and may have a more specific handling instruction applicable to a specific account or applicable to a specific class or type of resource or transfer category, e.g. payroll payments or tax refunds. If there is more than one handling instruction triggered, then in operation 316 the system resolves which handling instruction is to take precedence. In some cases, a priority ranking of handling instructions may be defined in the system when setting the handling instructions. In some cases, a more specific handling instruction may take precedence in the absence of a defined priority ranking. In some cases, the most recent handling instruction may take precedence in the absence of a defined priority ranking. Other conflict resolution processes or algorithms may be applied to determine which handling instruction is to be implemented in the cases were more than one is triggered.

The handling instruction specifies an alternative routing of the transferred resources from the transfer message. Whereas the transfer message specifies that the transferred quantity of resource is to be allocated to a main recipient account, the handling instructions may indicate that, if triggered, at least a portion of that quantity of resources is to be re-allocated to a different account. The different account may an account managed by the transfer processing system, e.g. recorded in the same database(s), or may be an external account at a third-party computing system.

In some cases, account holder confirmation may be sought prior to implementing the predefined handing instruction. Accordingly, in this example in operation 318 the system assesses whether authorization is to be obtained. The need for authorization may be a configurable setting in connection with the account configuration. In some cases, an account holder may disable the requirement for obtaining confirmation or authorization. In some cases, the requirement to obtain authorization may be set at the handling instruction level; that is, each handling instruction may indicate whether authorization is required or not. A system level default may be applicable in some implementations.

If authorization is required, then in operation 320 the system sends a notification to an address associated with the recipient account holder. The notification may be an app notification, a text message, an email, an automated telephone call, or other such communications. In some cases, multiple notification may be sent using different modalities. The notification may include a selectable button, link, or other software mechanism for causing a response message to be returned to the transfer processing system indicating confirmation or denial of the authorization. That is, the notification is displayed on a client device associated with the address used for the notification, and through a user input at the client device a response message is generated and sent to the transfer processing system. The response message indicates whether the handling instruction is to be applied or not. In some cases, the notification may include display of details of the handling instruction, such as the account to which a quantity of resources is to be re-allocated as a result of the handling instruction.

In operation 322, the system assesses whether it has received authorization. If authorization is denied, then the method 300 continues to operation 308 to process the transfer message without re-direction or re-allocation. That is, the transfer quantity will be recorded in association with the main recipient account specified in the transfer message and no special handling will be applied.

If authorization is not needed, or is granted, then in operation 324 the system applies the re-direction or re-allocation specified in the applicable handling instruction. In some cases, this includes recording the transfer quantity in association with the main recipient account and then generating a new transfer message or instruction to remove some portion or all of the transfer quantity from the main recipient account and record it in association with the different account specified in the transfer instruction. In some cases, the handling includes recording the portion or all of the transfer quantity in association with the different account without first recording it in connection with the main recipient account.

The different account may be an account local to the transfer processing system; that is, another account with the same entity or institution. To use monetary resources and a financial example, an incoming transfer message may allocate funds to a main chequing account of a recipient, but the handling instruction may specify that the funds, or a portion thereof, are to be directed to a savings account, a mortgage account, a credit card account, or some other account held by the same recipient with the same financial institution. The handling instruction may be conditional on a transfer category or type specified in the metadata in the transfer message, such as “wages” or “windfall” or “spousal support”, etc. When the account is internal to the same institution, then the transfer processing system may execute an internal transfer operation to re-direct the resources from the main account to the different account, or may simply record the funds directly to the different account without first recording them in the main account.

In some cases, the different account may be associated with a different entity and computing system. To use the monetary example above, the different account could be a bank account, investment account, mortgage account, or loan account at a different financial institution. In another example, the different account could be a utility account, rental account, or other such account to which funds may be directed in payment of outstanding bills. If the account is an external account, the transfer processing system may record the transfer quantity in association with the main recipient account and then generate and send a further transfer message, command, or instructions effecting transfer of the quantity, or a portion thereof, to the specified different account. The transfer message may be by a bill payment message, an EFT (electronic funds transfer) transaction, an ACH (automated clearing house) transaction, a wire, or a real-time payment message, as examples.

In one example, the re-allocation may include a re-allocating the resources to exchange them for another item or resource. For example, the re-allocation may include a purchase. One example purchase is a stock, bond, or other security. The handling instructions in such examples may be configured to redirect certain transferred resources or a portion thereof to an investment account as part of a preconfigured trading operation. In one example, a certain percentage of any payment the includes the metadata “payroll” may be redirected to a retirement investment account to be invested in one or more securities, such as certain mutual funds or exchange traded funds. In another example, the receipt of a particular computing resource from a specified transferor may be automatically redirected by the handling instructions to a third party in exchange for a different resource. As an example, server time transferred to the recipient may be automatically resold to a third party.

In another example, the re-allocation operation includes, either instead of or in addition to re-routing the resources, sending a notification to the recipient regarding receipt of the transfer. For instance, the handling instruction may include searching metadata for a particular payor or invoice number, and sending a notification that it has been received.

The trigger condition defined in a handling instruction may be based on matching metadata within the transfer message to a selected word or code in the handling instruction. In some implementations, the word or code is metadata inserted in the structured transfer message in a field designated for including metadata regarding the transfer. In some cases, the metadata may indicate a transfer category or type or purpose. In some implementations, a plurality of predefined categories or purposes may be provided and a transfer message may include one of those predefined categories or purposes. In some cases, the transfer message may include a code or other indicator specifying one of the predefined categories or purposes. Example categories or purposes of transfers may include, for instance, payroll, tax refund, gift, expense reimbursement, windfall, services payment, goods payment, dividend, etc. In some cases, subcategories or purposes may be defined. For instance, the purpose “expense reimbursement” may be subdivided or have separate categories for “medical expense”, “transportation expense”, “legal expense”, “travel expense”, etc.

When configuring a handing instruction, a user may be able to select from pre-defined purposes or categories when creating the handling instruction. An account management application, such as a banking app, or a web interface for account management may be used to configured handling instructions.

Transfer messages may be generated using a web-based or application-based interface for creating and executing transfer of resources. The interface may provide for selection or entry of transfer category or purpose. In some cases, the selection may be from a predefined list of transfer categories or purposes.

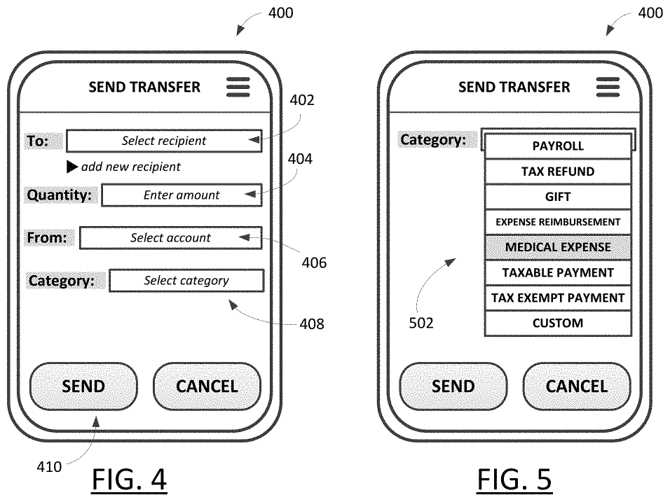

Reference will now be made to FIGS. 4 and 5 which show one illustrative example of a graphical interface 400 for creating and sending a transfer message. FIG. 4 illustrates a first page of the graphical interface 400 and FIG. 5 illustrates a subsequent page of the graphical interface 400. The graphical interface 400 in this example is a simplified interface that may be displayed on a mobile device, such as a smartphone or tablet. Other interfaces may provide additional graphics, options, functions, and features.

The first page of the graphical interface 400 may include graphics or text data providing guidance to a user in generating and sending a transfer message. The first page may be reached from a main menu, drop down menu, selection box, or other selectable element. The first page may enable a user to select a recipient, as indicated by reference numeral 402. The recipient field may be a drop down menu of predefined recipients or previously-entered recipients. The graphical interface 400 may further provide the capability of entering a new recipient, including the providing of the recipient name, contact data, account information, etc. Recipients defined within the system may have stored information associated with the recipient name, such as account data. Account data may include, for instance, a financial institution identifier, branch data and account number. Account data may include a non-banking account number, such as a public key corresponding to a cryptocurrency account. Other account data may be stored in association with the recipient name or other recipient identifier. In some cases, the recipient identifier displayed on the graphical interface 400 may be a handle, nickname, email address, social media handle, or other identifier. In some cases the recipient's legal name may be stored in memory in association with the recipient identifier.

The graphical interface 400 may also enable entry or selection of a transfer quantity 404. In some cases, a type of resource may be selected (not shown). As an example, in the case of transfer of monetary funds, for instance, the currency may be selectable. In another example, in the case of transfer of cryptocurrency, the type of cryptocurrency may be selectable. In yet another example, if the resources are other fungible items, such as units of processing time on a server, or bandwidth allocation on a network, etc., then the graphical interface 400 may permit selection of one of those resources.

In some implementations, the user may also select an account 406 from which the resources are to be transferred, if the user has more than one account storing available resources.

The graphical interface 400 may further permit the user to select or enter metadata to be inserted in the transfer message. In this example, the graphical interface 400 permits selection of a transfer category 408 or purpose.

Once the user has selected items for the required fields, a selectable send button 410 or icon may be activated. The send button 410, once selected, may result in verification of the data entered for compliance with any requirements for a valid transfer by the client device displaying the graphical interface 400. The client device may then generate and send the transfer message, which contains identification or contact data for the recipient, such as a name, email address, social media handle, public key, account number of other such data. In some cases, the transfer message includes both a recipient identifier and an account number, so that the receiving system may verify that the recipient identifier and account number match their records and are associated with each other. The transfer message further includes the transfer quantity and, in some cases, the resource type and/or an identifier for the account from which the resources are transferred. The transfer message further includes metadata, such as the transfer category or purpose selected or entered by the user when generating the transfer message. In some cases, the transfer category or purpose may be inserted based on the type of resource, the type of sender, or the type of account from which the transfer is sent, without necessarily requiring entry or selection of a category by the user of the client device.

As shown in FIG. 5, in this example, activation of the transfer category 408 menu or field on the first page may result in a subsequent page or a pull-down menu providing a list 502 of pre-defined transfer categories or purposes. In some other implementations, the field may be a free form text field in which the user may enter any alphanumeric text. In this example, however, the user is restricted to pre-defined categories or purposes, which make it easier for the recipient system to match the metadata to a condition in a transfer instruction. Although various example categories or purposes are shown in the list 502 in FIG. 5, it will be appreciated that the present application is not limited to those pre-defined categories or purposes and that other categories or purposes may be defined or implementations may include only a subset of those categories or purposes.

The transfer message sent may be a structured data message with one or more defined fields including at least one of a recipient identifier and an account number. Additional metadata may be included in one or more fields in the structured data message. In some cases, the metadata includes one or more transfer types, categories, purposes, or other metadata regarding the transfer. The categories or purposes may be the category or purpose text selected using the list 502, or may be a code or identifier corresponding to that predefined category or purpose. The transfer message may be an ISO20022 data message in some implementations.

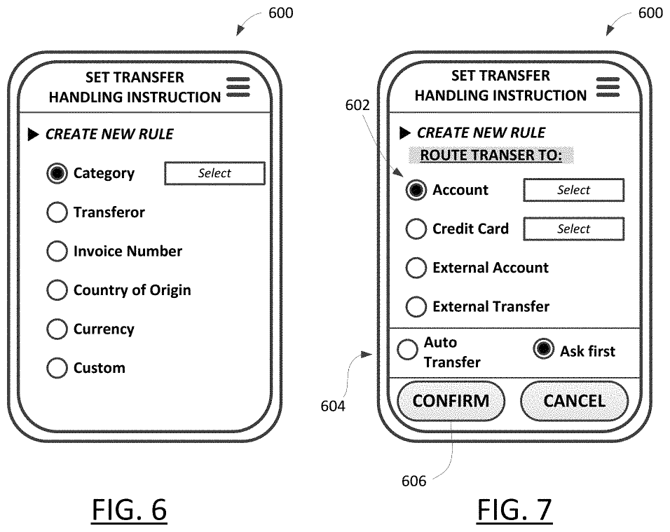

Reference is now made to FIG. 6, which shows a graphical interface 600 for creating and storing a handling instruction in connection association with a recipient or recipient account. FIG. 6 illustrates a first page of the graphical interface 600 and FIG. 7 illustrates a subsequent page of the graphical interface 600. The graphical interface 600 in this example is a simplified interface that may be displayed on a mobile device, such as a smartphone or tablet. Other interfaces may provide additional graphics, options, functions, and features.

In some instances, the graphical interface 600 may be displayed by an account management application that may be installed on a client device. In some instances, the graphical interface 600 may be a web browser interface obtained by logging into an account management system at the recipient computing system. The account management system may provide web-based access to account management functions and operations similar to those available through use of the account management application. The first page of the graphical interface 600 shown in FIG. 6 may be displayed in response to user selection of a “set transfer handling instruction” option in a main menu or submenu within the application or web browser interface. The graphical interface 600 may provide the option of creating a new transfer handling instruction or editing existing transfer handling instructions.

As shown in FIG. 6, if “create new rule” is selected, the graphical interface 600 may provide the ability to select a trigger condition for the new rule. In this example, the trigger condition may be selected based on a radio button, but any other graphical elements, menus or fields may be used to enable selection of a trigger condition. In this example, the available types of trigger conditions may include “category”, “transferor”, “invoice no.”, “country of origin”, “currency”, and “custom”. Fewer, more, or other conditions may be specified in other examples. The “category” option, as indicated, may provide the ability to select from a set of predefined categories or purposes for the transfer. These predefined options may correspond to the options available when configuring the sending of a transfer message, such as those shown in FIG. 5. The “transferor” option may make the trigger condition dependent upon an identifier of the transferor or sender of the transfer message. The “invoice no.” option, may enable specifying the handling of a resource transfer relating to a specific invoice number or purchaser order number or the like. The “country of origin” option may enable setting a trigger condition for special handling of any resource transfer from a specific country, for example if custom reporting or routing of those resources is desirable or mandated due to the country of origin. “Currency” may enable the special handling of specific currencies or other types of resources. Finally, “custom” may permit a user to set a custom trigger condition using a free form alphanumeric field to specify certain metadata to search for in the transfer message to trigger the handling instruction. In some implementation, the graphical interface 600 may permit the selection of more than one condition and the logical combination of trigger conditions, for example using AND, OR, NOT, and other logic conditions.

Once the trigger condition has been specified, then the graphical interface 600 may enable the configuration of the re-allocation or re-routing operations that result from detection of the trigger condition, as illustrated in FIG. 6. The graphical interface 600 may permit selection of an account to which the transfer quantity of resources it to be redirected. In some cases, the portion of reallocated resources, whether a set amount or a percentage, may be configurable. Similarly, one of the possible trigger conditions may be transfers in which the resources exceed a certain set threshold quantity, or are below a certain set threshold quantity. The amount reallocated may be all of the resource, a specified percentage of the resources, or a fixed quantity.

The graphical interface 600 may permit selection of one (or more) accounts local to the recipient computing system, as indicated by reference numeral 602. In some cases, the graphical interface 600 may permit selection of a credit-based account such as a credit card, loan, or mortgage account or the like, in which case the re-allocated resource may be treated as a pre-payment, payment, credit, etc. In some cases, the user may be permitted to select an external account or an external transfer. For instance, the user may be permitted to specify an account at a third-party financial institution, a bill payment, a government tax account, an investment account, etc. In some cases, the user may be permitted to specify a particular individual or corporate entity to which to transfer the resources using a resource transfer mechanism, such as an email money transfer, EFT, ACH, wire, cryptocurrency transaction, or the like. Selection of these options may require that the user input various identifying data for the external account, entity, or person and provide certain confirmations and identifying details to enable creation and execution of such transfers.

The graphical interface 600 may, in some cases, permit the user to specify whether the handling instruction is to be automated or whether it requires real-time authorization, as indicated by reference numeral 604. Once the necessary selections and configuration data has been provided, a “confirm” button 606 or icon may become activated, enabling the user to save the handling instruction to memory.

The handling instruction created using the graphical interface 600 may be saved at the recipient computing system in association with the user and/or one or more of the user's accounts with the recipient computing system. A similar interface may be provided for editing existing handling instructions.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system for handling a transfer, comprising:
a processor;
a communications module coupled to the processor; and
a memory coupled to the processor, the memory storing processor-executable instructions that, when executed by the processor, cause the processor to:
receive, from a remote system via the communications module, a transfer message including a transfer quantity and containing metadata regarding the transfer;
identify a main recipient account based on the transfer message;
based on the metadata regarding the transfer, detect a trigger condition, wherein the trigger condition is defined in a handling instruction stored in the memory, the handling instruction including a transfer re-routing action specifying a second recipient account; and
in response to detecting the trigger condition, cause at least a portion of the transfer quantity to be recorded in association with the second recipient account.

2. The computing system of claim 1, wherein the metadata includes a transfer categorization associated with the transfer message.

3. The computing system of claim 2, wherein the transfer categorization is selected from a list of predefined transfer categorizations.

4. The computing system of claim 3, wherein the list of predefined transfer categorizations includes at least one of gift, refund, windfall, or payroll.

5. The computing system of claim 1, wherein the transfer message includes a structured data message having predefined field structure, and wherein the metadata is stored in one or more fields in the predefined field structure.

6. The computing system of claim 1, wherein the instructions, when executed, further cause the processor to validate the metadata by comparing the metadata to a list of predefined transfer categorizations and identifying a match to one of the predefined transfer categorizations, and wherein the trigger condition specifies said one of the predefined transfer categorizations.

7. The computing system of claim 1, wherein the instructions, when executed, further cause the processor to first receive input defining the handling instructions.

8. The computing system of claim 7, wherein the input further includes a selection of the trigger condition from a list of defined trigger conditions.

9. The computing system of claim 1, wherein the instructions, when executed are to cause by recording the transfer quantity in association with the main recipient account and generating an account transfer operation to record removal of the transfer quantity from the main recipient account and to record credit of the transfer quantity to the second recipient account.

10. The computing system of claim 1, wherein the instructions, when executed are to cause by causing the transfer quantity to be recorded in association with the second recipient account without previously recording the transfer quantity in association with the main recipient account.

11. The computing system of claim 1, wherein the second recipient account is stored at a third party server, and wherein the instructions, when executed are to cause by generating and sending a transfer operation message to the third party server thereby effecting transfer of the transfer quantity from the main recipient account to the second recipient account.

12. The computing system of claim 1, wherein the handling instruction further includes a notification action and the instructions, when executed, are to cause the processor to generate and send a notification message to a recipient contact address regarding receipt of the transfer quantity.

13. A computer-implemented method for handling a transfer, comprising:
receiving, from a remote system, a transfer message including a transfer quantity and containing metadata regarding the transfer;
identifying a main recipient account based on the transfer message;
based on the metadata regarding the transfer, detecting a trigger condition, wherein the trigger condition is defined in a handling instruction stored in memory, the handling instruction including a transfer re-routing action specifying a second recipient account; and
in response to detecting the trigger condition, causing at least a portion of the transfer quantity to be recorded in association with the second recipient account.

14. The method of claim 13, wherein the metadata includes a transfer categorization associated with the transfer message.

15. The method of claim 14, wherein the transfer categorization is selected from a list of predefined transfer categorizations.

16. The method of claim 15, wherein the list of predefined transfer categorizations includes at least one of gift, refund, windfall, and payroll.

17. The method of claim 13, wherein the transfer message includes a structured data message having predefined field structure, and wherein the metadata is stored in one or more fields in the predefined field structure.

18. The method of claim 13, further comprising validating the metadata by comparing the metadata to a list of predefined transfer categorizations and identifying a match to one of the predefined transfer categorizations, and wherein the trigger condition specifies said one of the predefined transfer categorizations.

19. The method of claim 13, further comprising first receiving input defining the handling instructions.

20. The method of claim 19, wherein the input further includes a selection of the trigger condition from a list of defined trigger conditions.

21. The method of claim 13, wherein causing includes recording the transfer quantity in association with the main recipient account and generating an account transfer operation to record removal of the transfer quantity from the main recipient account and to record credit of the transfer quantity to the second recipient account.

22. The method of claim 13, wherein causing includes causing the transfer quantity to be recorded in association with the second recipient account without previously recording the transfer quantity in association with the main recipient account.

23. The method of claim 13, wherein the second recipient account is stored at a third party server, and wherein causing includes generating and sending a transfer operation message to the third party server thereby effecting transfer of the transfer quantity from the main recipient account to the second recipient account.

24. The method of claim 13, wherein the handling instruction further includes a notification action and causing further includes generating and sending a notification message to a recipient contact address regarding receipt of the transfer quantity.
